(19) United States
(12) Patent Application Publication
(10) Pub. No.: US 2018/0063001 A1
(43) Pub. Date: Mar. 1, 2018

(54) SERVER APPARATUS AND VIRTUAL COMMUNICATION CONSTRUCTION METHOD

(71) Applicant: Fujitsu Limited, Kawasaki-shi (JP)

(72) Inventor: Shinya KANO, Inagi (JP)

(73) Assignee: Fujitsu Limited, Kawasaki-shi (JP)

(21) Appl. No.: 15/677,394

(22) Filed: Aug. 15, 2017

(30) Foreign Application Priority Data
Aug. 23, 2016 (JP) 2016-163089

(51) Int. Cl. H04L 12/803; H04L 12/751; H04L 12/26

(52) U.S. Cl. CPC H04L 47/125; H04L 43/08; H04L 45/02

(57) ABSTRACT

A server apparatus includes a memory, and a processor coupled to the memory and the processor configured to determine a number of a virtual-distribution-function to be arranged at a previous stage of a first virtual-communication-function group arranged at a forefront stage among a plurality of virtual-communication-function groups arranged at a plurality of stages, the virtual-distribution-function distributing traffic to a virtual-communication-function in the first virtual-communication-function group, determine a transmission path from the virtual-communication-function in the first virtual-communication-function group up to the virtual-communication-function in a final virtual-communication-function group arranged at a terminal stage among the plurality of virtual-communication-function groups, determine a distribution ratio of the traffic of the virtual-distribution-function for the virtual-communication-function in the first virtual-communication-function group, based on a traffic amount for the determined transmission path, set the determined transmission path into the virtual-communication-function, and set the determined distribution ratio into the virtual-distribution-function.

### CROSS-REFERENCE TO RELATED APPLICATION

This application is based upon and claims the benefit of priority of the prior Japanese Patent Application No. 2016-163089, filed on Aug. 23, 2016, the entire contents of which are incorporated herein by reference.

### FIELD

The embodiments discussed herein are related to a server apparatus and a virtual communication construction method.

### BACKGROUND

In a recent network, there is a service chain system in which, when an access is performed from a base location to an external site or from the base location to another base location, network (NW) functions such as firewalls (FWs) and Proxies are virtually arranged on communication paths in response to a request, and packets are transmitted. The communication paths passing through the virtual NW functions are referred to as the service chain.

In related art, the NW functions have been operated in a physical NW device such as a NW server. However, with the recent performance enhancement of a commercial off-the-shelf (COTS) server, the NW functions may also be operated in a software processing on the COTS server. Therefore, the operation of the NW functions has been started in the form in which programs of the NW functions are operated on a virtual machine under a virtual environment of the COTS server. Herein, the NW related software processing that is operated on the virtual machine is referred to as a virtual network function (VNF).

However, as the operation mode of the NW related processing such as data transmission has shifted from the physical NW device to the VNF of the software processing on the COTS server, deterioration of the processing performance of the data transmission has occurred. Thus, the processing performance of the data transmission has been improved by executing a plurality of programs in parallel to cause virtual machines to be operated in parallel on a plurality of servers so as to distribute the load on the data transmission.

FIG. 14 is an explanatory diagram illustrating an example of an arrangement configuration of a service chain. In a service chain 200 illustrated in FIG. 14, VNFs 201 such as FWs 201A, intrusive detection systems (IDSs) 201B, and Proxies 201C are arranged. Further, in the service chain 200, load balancers (LBs) 202 are virtually arranged at the previous stages of the VNFs 201, respectively, to distribute a traffic load. The LBs 202 distribute the loads to the VNFs 201 arranged at the next stages of the LBs 202, respectively. As a result, the loads of the transmission processing of the respective VNFs 201 are distributed so that the deterioration of the processing performance due to the software processing is suppressed.

Related techniques are disclosed in, for example, Japanese Laid-Open Patent Publication Nos. 2015-154325 and 2016-046603, and International Publication Pamphlet No. WO 2014/208661.

### SUMMARY

According to an aspect of the invention, a server apparatus includes a memory, and a processor coupled to the memory and the processor configured to determine a number of a virtual distribution function to be arranged at a previous stage of a first virtual communication function group arranged at a forefront stage among a plurality of virtual communication function groups arranged at a plurality of stages, the virtual distribution function distributing traffic to a virtual communication function in the first virtual communication function group, determine a transmission path from the virtual communication function in the first virtual communication function group up to the virtual communication function in a final virtual communication function group arranged at a terminal stage among the plurality of virtual communication function groups, determine a distribution ratio of the traffic of the virtual distribution function for the virtual communication function in the first virtual communication function group, based on a traffic amount for the determined transmission path, set the determined transmission path into the virtual communication function, and set the determined distribution ratio into the virtual distribution function.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a service chain system;

FIG. 2 is an explanatory diagram illustrating an example of a hardware configuration of a management server;

FIG. 3 is an explanatory diagram illustrating an example of a service chain;

FIG. 4 is a flowchart illustrating an example of a processing operation of the management server that is related to a first service chain construction processing;

FIG. 5 is an explanatory diagram illustrating an example of a traffic distributing method of an integrated LB of the service chain illustrated in FIG. 3;

FIG. 6 is an explanatory diagram illustrating an example of a service chain according to a first embodiment;

FIG. 7 is an explanatory diagram illustrating an example of a functional configuration of a processor of a management server according to the first embodiment;

FIG. 8 is an explanatory diagram illustrating an example of a terminal receiving destination within a second section;

FIG. 9 is an explanatory diagram illustrating an example of a transmission path of each VNF within the second section;

FIG. 10 is an explanatory diagram illustrating an example of a load ratio of a transmission path of each VNF within the second section;

FIG. 11 is an explanatory diagram illustrating an example of a distribution ratio of an LBGW;

FIG. 12 is a flowchart illustrating an example of a processing operation of the management server that is related to a second service chain construction processing;

FIG. 13 is an explanatory diagram illustrating an example of an information processing apparatus that executes a service chain construction program; and

FIG. 14 is an explanatory diagram illustrating an example of an arrangement configuration of a service chain.

### DESCRIPTION OF EMBODIMENTS

In the VNFs 201 constituting the service chain 200, the LBs 202 are required for the respective VNFs 201, and a transmission delay occurs whenever signals pass through each of the LBs 202. Moreover, in the service chain 200, since the multiple LBs 202 are required, a resource of a virtual area on a COTS server is used.

Hereinafter, embodiments of a server apparatus and a virtual communication construction method of the present disclosure will be described in detail with reference to the accompanying drawings. Meanwhile, the disclosed technology is not limited to the embodiments. Further, the embodiments described below may be appropriately combined with each other within a scope that does not cause contradiction.

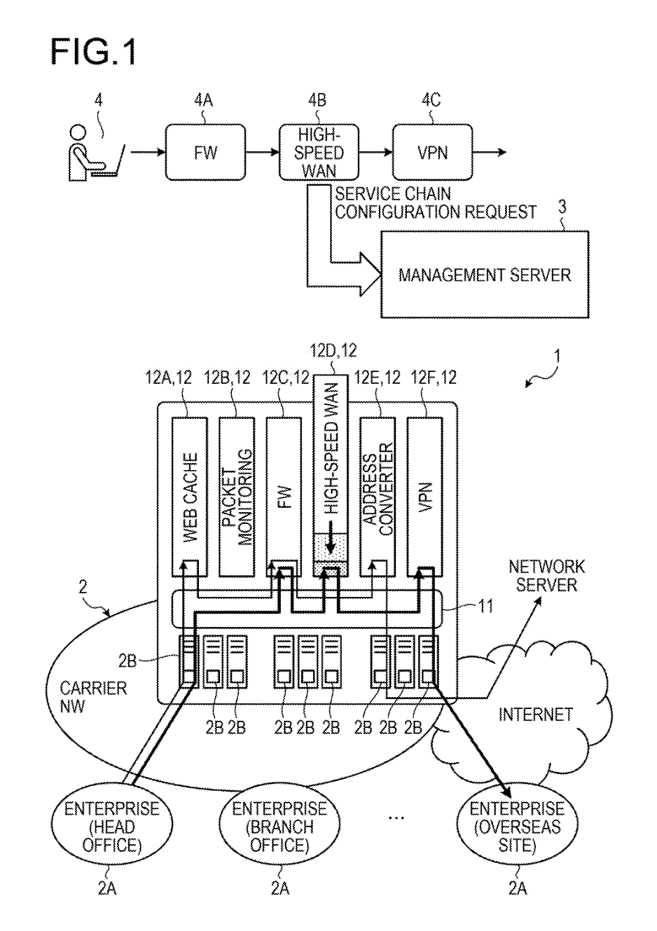

FIG. 1 is an explanatory diagram illustrating an example of a service chain system 1. The service chain system 1 illustrated in FIG. 1 includes a carrier NW 2, a management server 3, and a terminal device 4. The carrier NW 2 is, for example, a NW that is connected to base locations 2A such as a head office, a branch office, or an overseas base location of an enterprise. The carrier NW 2 is constituted by, for example, a plurality of COTS servers 2B and includes a virtual NW 11 that is actuated in a virtual area positioned in a resource area of each COTS server 2B, and a plurality of VNFs 12 arranged on the virtual NW 11. The management server 3 establishes a service chain in which a communication is performed between the base locations 2A, in the virtual area.

Each VNF 12 is a virtual NW function such as a Web cache 12A, a packet monitoring 12B, an FW 12C, a high-speed WAN 12D, an address converter 12E, a VPN (virtual private network) 12F, an IDS, or a Proxy. The Web cache 12A is a NW function that stores cache data with a Web server (not illustrated). The packet monitoring 12B is a NW function that monitors the state of a packet on a communication path. The FW 12C is a NW function that prevents an unauthorized access. The high-speed WAN 12D is a NW function such as a high-speed WAN. The address converter 12E is a NW function that converts an address. The VPN 12F is a NW function such as a virtual private line. The IDS (not illustrated in FIG. 1) is a NW function that detects an illegal intrusion from the outside. The Proxy (not illustrated in FIG. 1) is a NW function of a proxy server. The VNFs 12 are virtual communication functions that are virtually arranged in the virtual area on the COTS server 2B.

The management server 3 is a server apparatus that arranges the desired virtual NW 11 and VNFs 12 on the virtual area of each COTS server 2B in the carrier NW 2 according to a configuration request of the service chain from the terminal device 4. The terminal device 4 is, for example, a terminal device of a system manager that is connected to the management server 3 via the FW 4A, the high-speed WAN 4B, or the VPN 4C to instruct the configuration request of the service chain to the management server 3. The configuration request is a command to request arrangement of one or a plurality of VNFs 12 on a communication path for the packet transmission. In addition, the configuration request may designate only the number of instances of the VNFs 12, in addition to designating the number of instances of the VNFs 12 and the LBs 13. Further, the configuration request may designate, for example, the request quality of the service chain. When detecting the configuration request that designates the request quality, the management server 3 determines the number of instances of the VNFs 12 or the LBs 13 from a desired function that is designated by the configuration request or the load status.

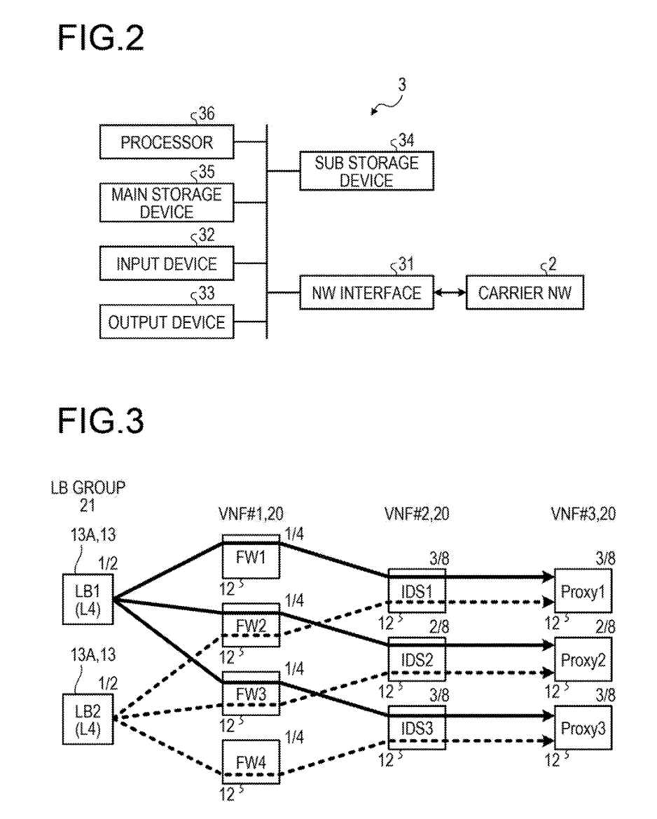

FIG. 2 is an explanatory diagram illustrating an example of a hardware configuration of the management server 3. The management server 3 illustrated in FIG. 2 corresponds to, for example, a dedicated or universal computer as a NW server. The management server 3 includes a NW interface 31, an input device 32, an output device 33, a sub storage device 34, a main storage device 35, and a processor 36. The NW interface 31 is a communication interface that is connected to the carrier NW 2 and further connected to the VNFs 12. The NW interface 31 is, for example, a communication interface that takes charge of wired or wireless communication. The NW interface 31 is, for example, a communication card such as a network interface card (NIC) or a local area network (LAN) card.

The input device 32 is an input interface such as a keyboard or a pointing device (e.g., mouse) that inputs various kinds of information. The output device 33 is an output interface such as a sound output device or a display device that outputs various kinds of information. The sub storage device 34 stores various programs or various kinds of information such as data used by the processor 36. For example, the sub storage device 34 is a non-volatile memory such as an erasable programmable ROM (EPROM) or a hard disk drive. Further, the sub storage device 34 is, for example, an area that stores an operating system (OS) or other various application programs.

The main storage device 35 is, for example, a semiconductor memory such as a random access memory (RAM), that provides an area where various kinds of information such as, for example, programs stored in the sub storage device 34 are loaded, or a working area. The processor 36 is a control unit such as a central processing unit (CPU), that controls the entirety of the management server 3. The processor 36 loads the OS or various application programs stored in the sub storage device 34 or a portable recording medium to the main storage device 35 to execute various processing functions. The number of processors 36 is not limited to one, but multiple processors 36 may be installed.

FIG. 3 is an explanatory diagram illustrating an example of the service chain. The service chain illustrated in FIG. 3 includes a plurality of VNF groups and an LB group. In the plurality of VNF groups, VNF #1, VNF #2, and VNF #3 are arranged in this order. VNF #1 includes, for example, FW 1 to FW 4. VNF #2 includes, for example, IDS 1 to IDS 3. VNF #3 includes, for example, Proxy 1 to Proxy 3. The LB group includes an LB 1 and an LB 2.

Upon detecting the configuration request, the processor 36 determines the number of integrated LBs 13A that are to be arranged at the previous stage of the VNF group 20 at the first stage, that is, VNF #1 in a predetermined order, based on the number of instances of the VNFs 12 in each of the VNF groups 20 that is designated in the configuration request. Herein, the predetermined order is, for example, the order in which VNF #1 (FWs), VNF #2 (IDSs), and VNF #3 (Proxies) are arranged in this order from the first stage.

Upon detecting the configuration request, the processor 36 specifies the LB group 21 of a higher layer “L4 level”(LBs (L4) for VNF #3) among the characteristics of the LBs 13 that distribute the traffic to the VNF groups 20, based on the configuration request. Further, the distribution processing in the unit of the L4 level (TCP session) may also execute a distribution processing in a unit of a L3 level (IP). The processor 36 specifies the LBs 13 (i.e., LBs (L4) for VNF #3) in which the number of LB instances becomes the maximum number, in the LB group 21 that executes the distribution processing of the higher layer “L4 level”, and determines the number of the LB instances as the number of instances of the integrated LBs 13A. That is, since the number of LB instances of VNF #3 is two L4 level LBs, the processor 36 determines the two L4 level LBs as the integrated LBs 13A. Herein, the reason for specifying the L4 level VNF group 20 is that the processing in the unit of the L3 level (IP) may also be executed by the processing in the unit of the L4 level (TCP session).

Further, the processor 36 determines a topology configuration with the arrangement order of VNF #1, VNF #2, and VNF #3. The processor 36 determines a topology configuration in which VNF #1 is arranged at the first stage of the service chain, VNF #2 is arranged at the next stage of VNF #1, VNF #3 is arranged at the next stage of VNF #2, and further, the integrated LBs 13A are arranged at the previous stage of VNF #1 at the first stage. Further, in the topology configuration, LB 1 and LB 2 in the integrated LBs 13A are disposed at the forefront stage, FW 1 to FW 4 in VNF #1 are disposed at the next stage of the LB1 and the LB 2, IDS 1 to IDS 3 in VNF #2 are disposed at the next stage of VNF #1, and Proxy 1 to Proxy 3 in VNF #3 are disposed at the next stage of VNF #2.

The processor 36 determines load distribution ratios of the integrated LBs 13A and load ratios of the VNFs 12 in order to distribute the load from the integrated LBs 13A to each VNF 12 in the VNF group 20 at the terminal stage among the plurality of VNF groups 20. The processor 36 determines the VNFs12 within the VNF group 20 which becomes the terminal among the plurality of VNF groups 20, and further determines an optimal path from the integrated LBs 13A to each of the VNFs 12 at the terminal stage.

Since the integrated LBs 13A are the L4 level LBs, the processor 36 determines, for example, Proxy 1 to Proxy 3 of VNF #3 as the terminal VNFs 12 where the L4 level becomes the terminal from the integrated LBs 13A. “LB 1” of the integrated LBs 13A determines three paths for Proxy 1 to Proxy 3. “LB 2” of the integrated LBs 13A also determines three paths for Proxy 1 to Proxy 3. The “LB 1” and “LB 2” of the integrated LBs 13A are terminal type LBs which may distribute the traffic as large as the number of the terminal VNFs 12. For example, since the terminal VNFs 12 are three of Proxy 1 to Proxy 3, the LB 1 may distribute the traffic to three paths.

The processor 36 calculates shortest paths by increasing link cost on a calculated path in a shortest path cost method such as the Dijkstra method, as the three paths from the “LB 1” of the integrated LB 13A to the terminal VNFs 12, that is, Proxy 1 to Proxy 3. The processor 36 determines optimal paths R1, R3, and R5 which are distributed paths passing through VNF #1 and VNF #2, by the shortest path calculation of the three paths from the LB 1 to the terminal VNFs 12. The processor 36 uses the shortest path cost method and performs the link cost addition for the three paths from “LB 2” to the terminal VNFs, that is, Proxy 1 to Proxy 3. Further, by the calculation, the processor 36 determines optimal paths R2, R4, and R6 which are distributed paths passing through VNF #1 and VNF #2.

The processor 36 determines distribution ratios of the loads from the integrated LBs 13A to the VNFs 12 at the first stage so that load amounts of the respective VNFs 12 of the VNF group 20 in which the number of instances of the VNFs 12 is the maximum number, are evenly distributed, among the VNF groups 20 arranged on the respective optimal paths R1 to R6. The processor 36 specifies the VNFs 12 with the maximum number, that is, VNF #1 (FW 1 to FW 4) among VNF #1 to VNF #3. The processor 36 calculates distribution ratios for distributing the loads to FW 1 to FW 4 in VNF #1 from the “LB 1” and the “LB 2” of the integrated LBs 13A so that the load amounts of FW 1 to FW 4 of VNF #1 become even, among the six optimal paths. For example, when the total load amount of the service chain is “1,” the distribution ratio from the LB 1 to the FW 1 becomes 1/4, the distribution ratio from the LB 1 to the FW 2 becomes 1/8, and the distribution ratio from the LB 1 to the FW 3 becomes 1/8. Further, the distribution ratio from the LB 2 to the FW 4 becomes 1/4, the distribution ratio from the LB 2 to the FW 2 becomes 1/8, and the distribution ratio from the LB 2 to the FW 3 becomes 1/8. As a result, the load amount of 1/4 is evenly allocated to each of the FW 1 to FW 4.

The processor 36 calculates the load ratio from each VNF 12 to the VNFs 12 at the next stage so that the load ratio of the load amount to each VNF 12 becomes optimal for each optimal path. After determining the distribution ratios of the loads to the FW 1 to FW 4 within VNF #1 from the “LB 1” and the “LB 2” of the integrated LBs 13A, the processor 36 determines transmission paths on the previously determined optimal paths R1 to R6 and further determines a distribution ratio to each VNF 12 on the transmission paths. The transmission path is a path in which the VNF 12 transmits the packet to the VNF 12 at the next stage among the optimal paths.

The transmission path of the “LB 1” of the integrated LBs 13A becomes a path of transmitting a packet addressed to the Proxy 1 to the FW 1, a path of transmitting a packet addressed to the Proxy 2 to the FW 2, and a path of transmitting a packet addressed to the Proxy 3 to the FW 3. The transmission path of the “LB 2” of the integrated LBs 13A becomes a path of transmitting the packet addressed to the Proxy 1 to the FW 2, a path of transmitting the packet addressed to the Proxy 2 to the FW 3, and a path of transmitting the packet addressed to the Proxy 3 to the FW 4.

Further, the transmission path of the FW 1 becomes a path of transmitting the packet addressed to the Proxy 1 to the IDS 1. The transmission path of the FW 2 becomes the path of transmitting the packet addressed to the Proxy 1 to the IDS 1 and a path of transmitting the packet addressed to the Proxy 2 to the IDS 2. The transmission path of the FW 3 becomes the path of transmitting the packet addressed to the Proxy 2 to the IDS 2 and a path of transmitting the packet addressed to the Proxy 3 to the IDS 3. The transmission path of the FW 4 becomes the path of transmitting the packet addressed to the Proxy 3 to the IDS 3.

Further, the transmission path of IDS 1 becomes a path of transmitting the packet addressed to the Proxy 1 to the Proxy 1. The transmission path of the IDS 2 becomes a path of transmitting the packet addressed to the Proxy 2 to the Proxy 2. The transmission path of the IDS 3 becomes a path of transmitting the packet addressed to the Proxy 3 to the Proxy 3. Further, the processor determines the load ratio of each VNF 12 so that the load amount of each VNF 12 of each transmission path becomes optimal. Herein, the load ratio of each VNF 12 is calculated by, for example, a weighted round robin scheme or a weighted HASH classification scheme.

The processor 36 determines the load ratio for each transmission path from VNF #1 to VNF #2. For example, the load ratio of the transmission path from the FW 1 to the IDS 1 becomes 2/8, the load ratio of the transmission path from the FW 2 to the IDS 1 becomes 1/8, and the load ratio of the transmission path from the FW 2 to the IDS 2 becomes 1/8. Further, the load ratio of the transmission path from the FW 3 to the IDS 2 becomes 1/8, the load ratio of the transmission path from the FW 3 to the IDS 3 becomes 1/8, and the load ratio of the transmission path from the FW 4 to the IDS 3 becomes 2/8.

Further, the processor 36 determines a load ratio for each transmission path from VNF #2 to VNF #3. For example, the load ratio of the transmission path from the IDS 1 to the Proxy 1 becomes 3/8, the load ratio of the transmission path from the IDS 2 to the Proxy 2 becomes 2/8, and the load ratio of the transmission path from the IDS 3 to the Proxy 3 becomes 3/8. Further, for convenience of descriptions, the load ratio of the transmission path from VNF #2 to VNF #3 is set as, for example, 3/8, 2/8, and 3/8, but the load ratio for each transmission path may be adjusted.

The processor 36 arranges the integrated LBs 13A and the VNFs 12 in the virtual area such as the COTS server 2B to actuate the functions of the integrated LBs 13A and the VNFs 12 based on the number of the integrated LBs 13A and the VNFs 12, the optimal paths R1 to R6, and the transmission paths. The processor 36 sets the determined distribution ratios of the integrated LBs 13A in the arranged integrated LBs 13A. The processor 36 sets the determined distribution ratio of each VNF 12 in the arranged VNFs 12. As a result, the service chain of the configuration request may be constructed under a virtual environment.

The management server 3 constructs the service chain of the configuration request in the virtual area of the designated COTS server 2B on the carrier NW 2 based on the integrated LBs 13A, the optimal paths from the integrated LBs 13A to the terminal VNFs 12, the distribution ratios of the integrated LBs 13A, and the load ratio of each VNF 12.

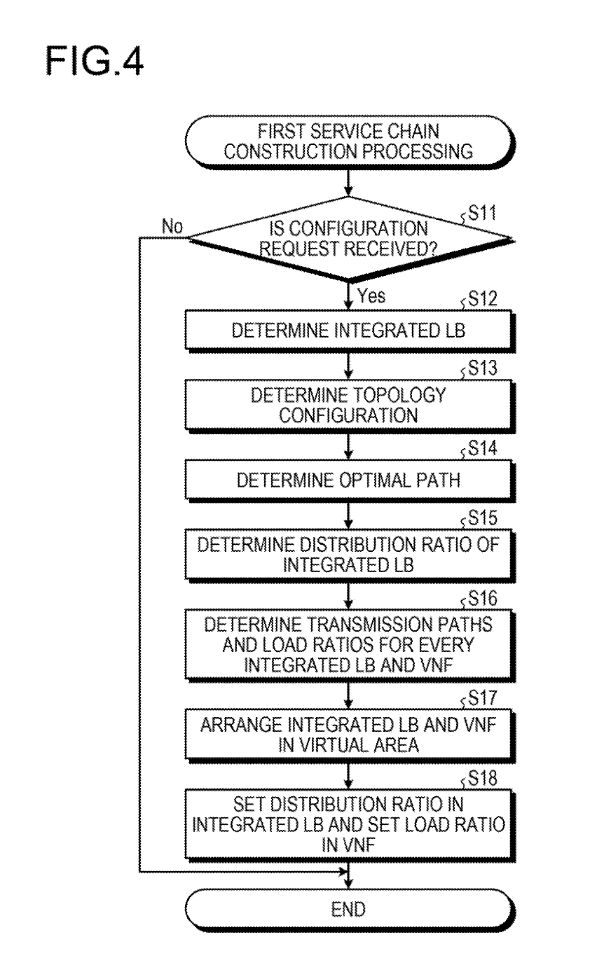

Subsequently, the service chain system 1 will be described. FIG. 4 is a flowchart illustrating an example of a processing operation of the management server 3 that is related to a first service chain construction processing.

In FIG. 4, the processor 36 in the management server 3 determines whether the configuration request is received from the terminal device 4 (operation S11). When it is determined that the configuration request is received (“Yes” in operation S11), the processor 36 determines the number of the integrated LBs 13A based on the number of instances of the VNFs 12 in the VNF groups 20 in the configuration request and the number of instances of the LBs 13 of each VNF group 20 (operation S12). Further, the processor 36 specifies the VNF group 20 in which the number of instances of the VNFs 12 is the maximum number among the VNF groups 20 at a higher level in the configuration request, and determines the number of LB instances of the specified VNF group 20 as the number of the integrated LBs 13A. In addition, the processor 36 determines a topology configuration of the integrated LBs 13A and the VNF group 20 based on the VNF group 20 in the configuration request as illustrated in FIG. 3.

The processor 36 determines the VNFs 12 in the VNF group 20 which becomes the terminal among the plurality of VNF groups 20, and further determines the optimal paths up to the VNF group 20 at the terminal stage from the integrated LBs 13A (operation S14). The processor 36 calculates and determines the distribution ratios of the loads from the integrated LBs 13A to each VNF 12 of the VNF group 20 at the first stage so that the traffic amounts (load amounts) of the respective VNFs 12 of the VNF group 20 with the maximum number of the VNFs 12 are evenly distributed, among the VNF groups 20 arranged on the respective optimal paths (operation S15).

The processor 36 determines the transmission path and the load ratio for each integrated LB 13A and each VNF 12 in each optimal path (operation S16). In addition, the processor 36 arranges the integrated LBs 13A and the VNFs 12 in the virtual area on the COTS server 2B and actuates the functions of the integrated LBs 13A and the VNFs 12 based on the integrated LBs 13A, the VNFs 12, the optimal paths, and the transmission paths (operation S17). Further, the processor 36 sets the distribution ratios of the integrated LBs 13A in the integrated LBs 13A on the virtual area, and further sets the load ratio of each VNF 12 in each VNF 12 on the virtual area (operation S18). Then, the processor 36 ends the processing operation illustrated in FIG. 4. As a result, the service chain of the configuration request may be disposed on the virtual area.

In the above-described example, the plurality of integrated LBs 13A are arranged at the forefront stage of the service chain, and the distribution ratios of the integrated LBs 13A and the load ratios of the respective VNFs 12 are determined so that the load amounts from the integrated LBs 13A up to the terminal VNFs 12 are evenly distributed. As a result, the number of the LBs 13 is decreased so that the transmission delay may be suppressed, and furthermore, the limited resources of the virtual area may be saved.

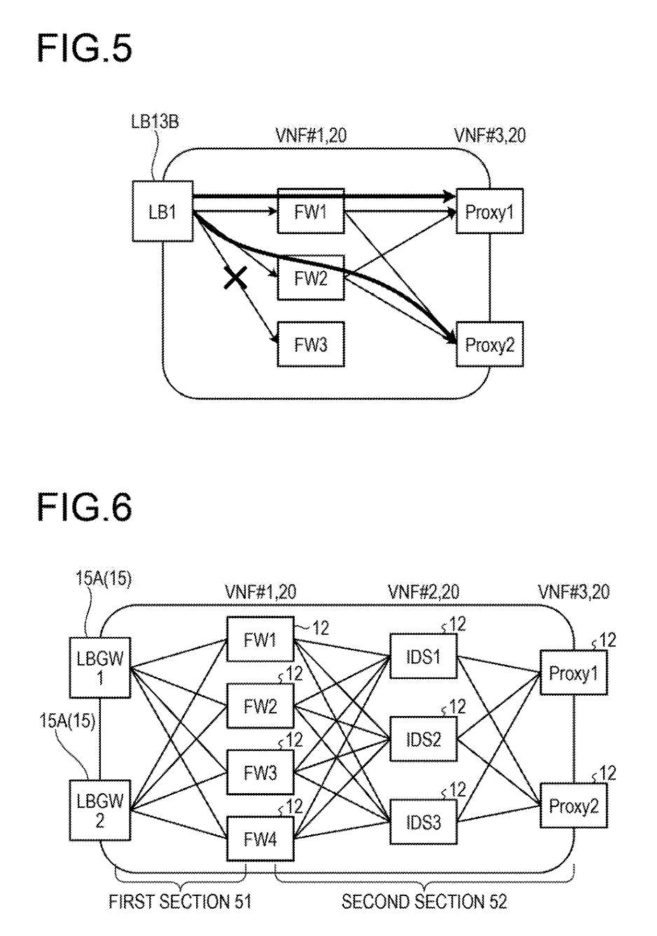

However, the integrated LB 13 used in the service chain is a terminal type LB that distributes the received traffic to a plurality of terminal receiving destinations. FIG. 5 is an explanatory diagram illustrating an example of an operation of the terminal type LB 13B. When the terminal type LB 13B illustrated in FIG. 5 is disposed at the previous stage of the FW 1 to FW 3, and the Proxy 1 and the Proxy 2 are disposed at the next stage of the FW 1 to FW 3, the number of the terminal VNFs which are terminal receiving destinations of the received traffic, that is, the number of Proxy 1 and Proxy 2 is two, and as a result, the received traffic may be distributed to two directions. That is, even though a plurality of VNFs 12 are additionally installed at the last stage, the terminal type LB 13B may distribute the loads only to the corresponding number of terminal-end VNFs 12 which are the terminal-end receiving destinations of the received traffic, regardless of the increase in number of VNFs 12. Therefore, even though the number of terminal-end VNFs 12, for example, FWs is increased at the last stage, the terminal type LB 13B may distribute the loads only to the corresponding number of FWs.

Accordingly, in order to cope with such a situation, an embodiment in which an LBGW is adopted in the integrated LB 13 of the service chain will be described below as a first embodiment. Meanwhile, the same reference numeral designates the same component as the service chain system 1, and as a result, descriptions of a component and an operation which are duplicated will be omitted.

### First Embodiment

An LBGW 15 is a relay type LB capable of relaying the received traffic to each VNF 12 in the VNF group 20 at the last stage, regardless of the terminal receiving destination of the received traffic.

FIG. 6 is an explanatory diagram illustrating an example of a service chain according to a first embodiment. The service chain illustrated in FIG. 6 includes a plurality of VNF groups 20 and an LBGW group 15. In the plurality of VNF groups 20, VNF #1, VNF #2, and VNF #3 are arranged in this order. VNF #1 includes, for example, FW 1 to FW 4. VNF #2 includes, for example, IDS 1 to IDS 3. VNF #3 includes, for example, Proxy 1 and Proxy 2. The LBGW group 15 includes an integrated LBGW 15A of an LBGW 1 and an LBGW 2.

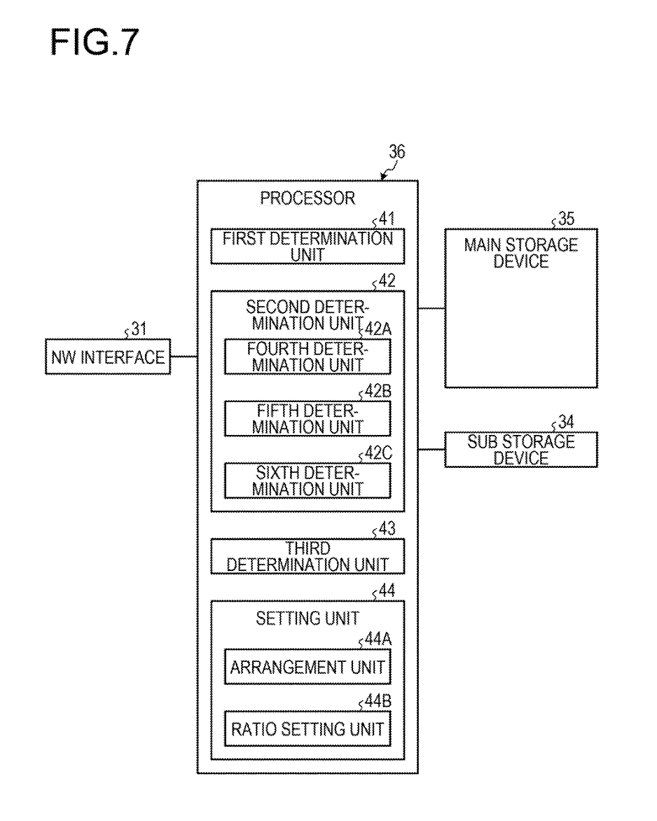

FIG. 7 is an explanatory diagram illustrating an example of a functional configuration of a processor 36 of a management server 3 according to the first embodiment. The processor 36 reads a program stored in a sub storage device 34 to execute the read program, and includes a first determination unit 41, a second determination unit 42, a third determination unit 43, and a setting unit 44 as functional components.

Upon detecting the configuration request, the first determination unit 41 determines the number of the integrated LBGWs 15A to be arranged at the previous stage of the VNF group 20 at the forefront stage, that is, VNF #1 in a predetermined order, based on the number of instances of the VNFs 12 in each VNF group 20 designated in the configuration request. Herein, the predetermined order is, for example, the order in which VNF #1 (FWs), VNF #2 (IDSs), and VNF #3 (Proxies) are arranged in this order from the first stage.

For example, since the number of LB instances of VNF #1 is four L4 level LBs, the first determination unit 41 determines the two L4 level LBs as the integrated LBGW 15A. Further, the first determination unit 41 determines a topology configuration with the arrangement order of VNF #1, VNF #2, and VNF #3. The first determination unit 41 determines a topology configuration in which VNF #1 is arranged at the forefront stage of the service chain, VNF #2 is arranged at the next stage of VNF #1, and VNF #3 is arranged at the next stage of VNF #2, and further, the integrated LBGW 15A are arranged at the previous stage of VNF #1 at the forefront stage, as illustrated in FIG. 6. The topology configuration is a configuration in which LBGW 1 and LBGW 2 in the integrated LBGW 15A are disposed at the forefront stage, FW 1 to FW 4 in VNF #1 are disposed at the next stage of the integrated LBGW 15A, IDS 1 to IDS 3 in VNF #2 are disposed at the next stage of VNF #1, and Proxy 1 and Proxy 2 in VNF #3 are disposed at the next stage of VNF #2. The second determination unit 42 divides a first section 51 between the integrated LBGW 15A and VNF #1 and a second section 52 between VNF #1 and VNF #3.

The second determination unit 42 determines the distribution ratio of the load of each VNF 12 in VNF #1 and the load ratio of the VNF 12 to distribute the traffic amounts up to the respective VNFs 12 in the terminal VNF group 20 among the plurality of VNF groups 20 from VNF #1 at the forefront stage in the second section 52. The second determination unit 42 determines the distribution ratio of the loads of FW 1 to FW 4 and the load ratio of the load of each VNF 12 in VNF #2 and VNF #3, to distribute the loads to Proxy 1 and Proxy 2 of VNF #3 at the terminal stage from FW 1 to FW 4 in VNF #1 at the forefront stage. The second determination unit 42 includes a fourth determination unit 42A, a fifth determination unit 42B, and a sixth determination unit 42C.

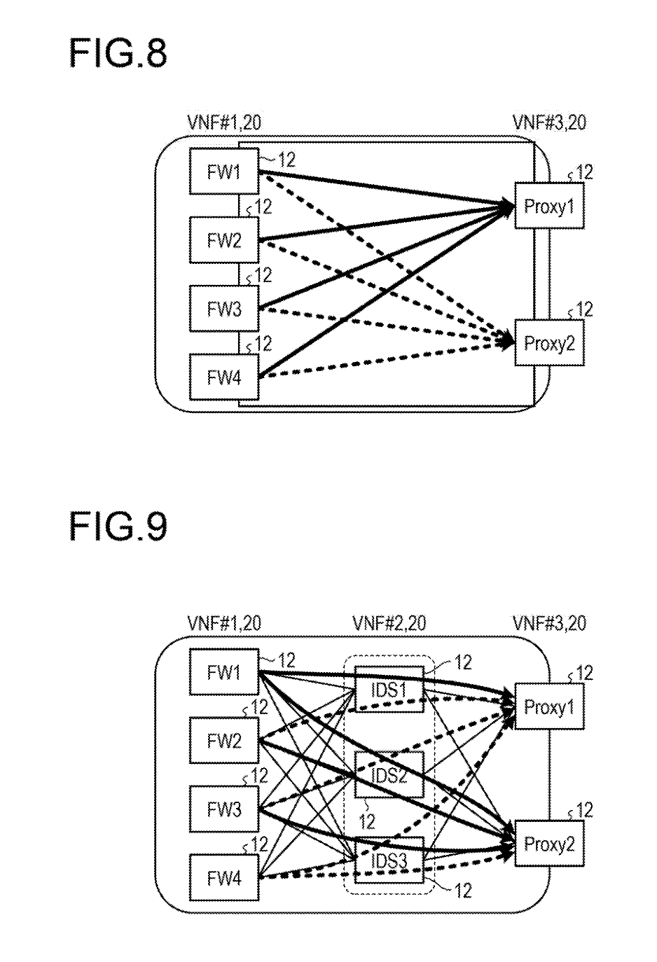

FIG. 8 is an explanatory diagram illustrating an example of a terminal receiving destination within a second section 52. The fourth determination unit 42A determines the VNF 12 in the VNF group 20 which becomes the terminal among the plurality of VNF groups 20 and determines an optimal path up to the VNF 12 at the terminal stage from the VNF 12 of VNF #1 at the forefront stage. The fourth determination unit 42A determines, for example, Proxy 1 and Proxy 2 of VNF #3 as the terminal VNF 12 which becomes the terminal from FW 1 to FW 4 in VNF #1 in the second section 52 as illustrated in FIG. 8. The FW 1 determines two paths for the Proxy 1 and the Proxy 2. The FW 2 determines two paths for the Proxy 1 and the Proxy 2. The FW 3 determines two paths for the Proxy 1 and the Proxy 2. The FW 4 determines two paths for the Proxy 1 and the Proxy 2. That is, the FW 1 to FW 4 become a total of eight paths as the paths addressed to the Proxy 1 and the Proxy 2.

FIG. 9 is an explanatory diagram illustrating an example of the transmission path of each VNF 12 within the second section 52. The fourth determination unit 42A calculates shortest paths by increasing link cost on a calculated path in a shortest path cost method such as the Dijkstra method, as the two paths up to the terminal VNF 12, that is, the Proxy 1 and the Proxy 2 from each of the FW 1 to FW 4 in VNF #1 at the forefront stage. In addition, the fourth determination unit 42A determines the shortest paths as the optimal paths which are distributed paths passing through VNF #2, by the calculation. The fourth determination unit 42A determines two paths up to the terminal VNF 12, that is, the Proxy 1 and the Proxy 2 from each of the FW 1 to FW 4 in VNF #1 at the forefront stage as the optimal paths which are distributed paths passing through VNF #2, by using the shortest path cost use method and adding link cost.

The fifth determination unit 42B determines the distribution ratios of the loads to the VNFs 12 of VNF #2 at the next stage from each VNF 12 in VNF #1 so that the loads of the respective VNFs 12 in a specific VNF group 20, for example, VNF #2 among the VNF groups 20 disposed on the respective optimal paths are evenly distributed.

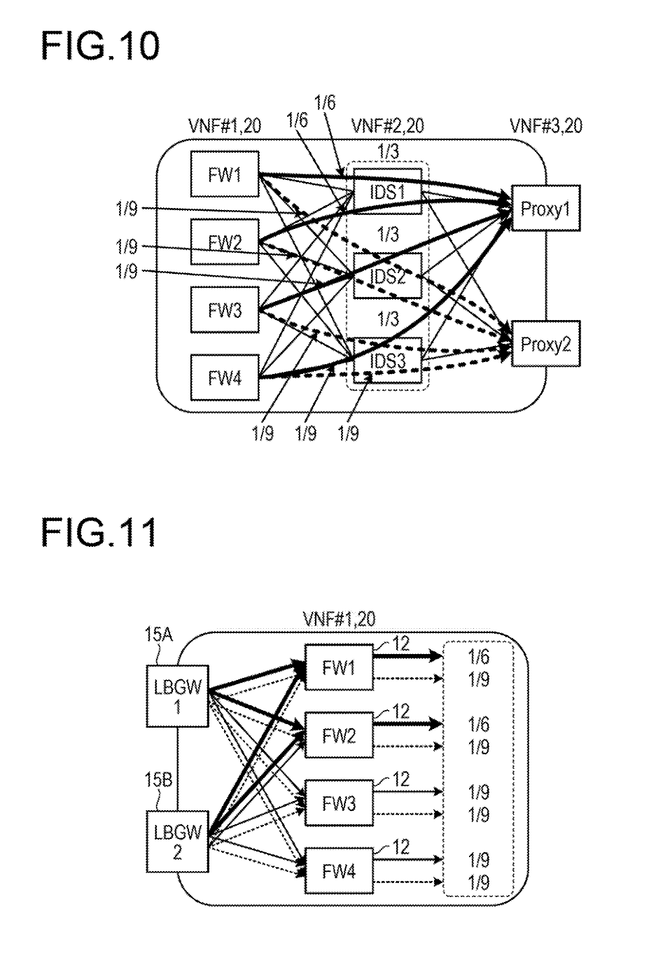

FIG. 10 is an explanatory diagram illustrating an example of a load ratio of a transmission path of each VNF 12 within the second section 52. The fifth determination unit 42B calculates the distribution ratio of distributing the loads to the IDS 1 to IDS 3 in VNF #2 from the FW 1 to FW 4 so that the load amounts of the IDS 1 to IDS 3 of VNF #2 are even among the eight optimal paths. For example, the distribution ratio addressed to the Proxy 1 from the FW 1 to the IDS 1 becomes 1/6, and the distribution ratio addressed to Proxy 2 from the FW 1 to the IDS 2 becomes 1/9. Further, the distribution ratio addressed to the Proxy 1 from the FW 2 to the IDS 1 becomes 1/6, and the distribution ratio addressed to Proxy 2 from the FW 2 to the IDS 2 becomes 1/9. The distribution ratio addressed to the Proxy 1 from the FW 3 to the IDS 2 becomes 1/9, and the distribution ratio addressed to Proxy 2 from the FW 3 to the IDS 3 becomes 1/9. Further, the distribution ratio addressed to the Proxy 1 from the FW 4 to the IDS 1 becomes 1/9, and the distribution ratio addressed to Proxy 2 from the FW 2 to the IDS 2 becomes 1/9. As a result, each of the load ratios of the IDS 1 to IDS 3 becomes 1/3.

The sixth determination unit 42C calculates the load ratio from each VNF 12 to the VNF 12 at the next stage so that the load ratio of the load amount to each VNF 12 becomes optimal for each optimal path. After the sixth determination unit 42C determines the distribution ratios of the loads from VNF #1 to the respective IDS 1 to IDS 3 in VNF #2 in the second section 52, the sixth determination unit 42C determines the transmission path on the optimal path which is first determined, and further determines the distribution ratio to each VNF 12 on the transmission path. The transmission path is a path in which the VNF 12 transmits the packet to the VNF 12 at the next stage among the optimal paths.

FIG. 11 is an explanatory diagram illustrating an example of a distribution ratio of an LBGW. The third determination unit 43 determines the distribution ratios of the respective LBGW 1 and LBGW 2 according to the distribution ratio of the load amounts of the FW 1 to FW 4 of VNF #1 at the forefront stage in the second section 52. The transmission path of the LBGW 1 illustrated in FIG. 11 becomes, for example, a path of transmitting the packet addressed to the Proxy 1 to the FW 1 to FW 4 and a path of transmitting the packet addressed to the Proxy 2 to the FW 1 to FW 4. The transmission path of the LBGW 2 becomes, for example, the path of transmitting the packet addressed to the Proxy 1 to the FW 1 to FW 4 and the path of transmitting the packet addressed to the Proxy 2 to the FW 1 to FW 4.

The third determination unit 43 determines 3/8 of the packets addressed to the Proxy 1 to be relayed to the FW 1, 3/8 of the packets addressed to the Proxy 1 to be relayed to the FW 2, 2/8 of the packets addressed to the Proxy 1 to be relayed to the FW 3, and 2/8 of the packets addressed to the Proxy 1 to be relayed to the FW 4, with respect to the LBGW 1 and the LBGW 2. The third determination unit 43 determines 1/4 of the packets addressed to the Proxy 2 to be relayed to the FW 1, 1/4 of the packets addressed to the Proxy 2 to be relayed to the FW 2, and 1/4 of the packets addressed to the Proxy 2 to be relayed to the FW 3, and 1/4 of the packets addressed to the Proxy 2 to be relayed to the FW 4, with respect to the LBGW 1 and the LBGW 2.

In the distributing setting of the LBGW 1 and the LBGW 2, 3/8 of the packets addressed to the Proxy 1 are relayed to the FW 1, 3/8 of the packets addressed to the Proxy 1 are relayed to the FW 2, and 2/8 of the packets addressed to the Proxy 1 are relayed to the FW 3, and 2/8 of the packets addressed to the Proxy 1 are relayed to the FW 4. Further, in the distributing setting of the LBGW 1 and the LBGW 2, 1/4 of the packets addressed to the

Proxy 2 are relayed to the FW 1, 1/4 of the packets addressed to the Proxy 2 are relayed to the FW 2, and 1/4 of the packets addressed to the Proxy 2 are relayed to the FW 3, and 1/4 of the packets addressed to the Proxy 2 are relayed to the FW 4, with respect to the LBGW 1 and the LBGW 2.

The transmission path of the FW 1 becomes a path of transmitting the packet addressed to the Proxy 1 to the IDS 1 and transmitting the packet addressed to the Proxy 2 to the IDS 2. The transmission path of the FW 2 becomes the path of transmitting the packet addressed to the Proxy 1 to the IDS 1 and transmitting the packet addressed to the Proxy 2 to the IDS 2. The transmission path of the FW 3 becomes the path of transmitting the packet addressed to the Proxy 1 to the IDS 2 and transmitting the packet addressed to the Proxy 2 to the IDS 3. The transmission path of the FW 4 becomes the path of transmitting the packet addressed to the Proxy 1 to the IDS 3 and the path of transmitting the packet addressed to the Proxy 2 to the IDS 3.

The transmission path of the IDS 1 becomes a path of transmitting the packet addressed to the Proxy 1 to the Proxy 1. The transmission path of the IDS 2 becomes the path of transmitting the packet addressed to the Proxy 1 to the Proxy 1, and the path of transmitting the packet addressed to the Proxy 2 to the Proxy 2. The transmission path of the IDS 3 becomes the path of transmitting the packet addressed to the Proxy 2 to the Proxy 2.

The sixth determination unit 42C determines the load ratio of each VNF 12 so that the load amount of each VNF 12 of each transmission path becomes optimal. Further, the load ratio of each VNF 12 is calculated by, for example, a weighted round robin scheme or a weighted HASH classification scheme.

The setting unit 44 includes an arrangement unit 44A and a ratio setting unit 44B. The arrangement unit 44A arranges the integrated LBGW 15A and the VNF 12 in the virtual area such as the COTS server 2B, etc., to actuate the functions of the integrated LBGW 15A and the VNEs 12 based on the numbers of the integrated LBGWs 15A and VNFs 12 and the transmission paths of the integrated LBGW 15A and the VNF 12.

The ratio setting unit 44B sets the distribution ratio of the integrated LBGW 15A determined by the third determination unit 43 in the arranged integrated LBGW 15A. The ratio setting unit 44B sets the load ratio of each VNF 12 determined by the fifth determination unit 42B and the sixth determination unit 42C in the arranged VNF 12. As a result, the service chain of the configuration request may be constructed under the virtual environment.

The management server 3 constructs the service chain of the configuration request in the virtual area of the designated COTS server 2B on the carrier NW 2 based on the transmission path for each of the integrated LBGW 15A and the VNF 12, the distribution ratio of the integrated LBGW 15A, and the load ratio of each VNF 12.

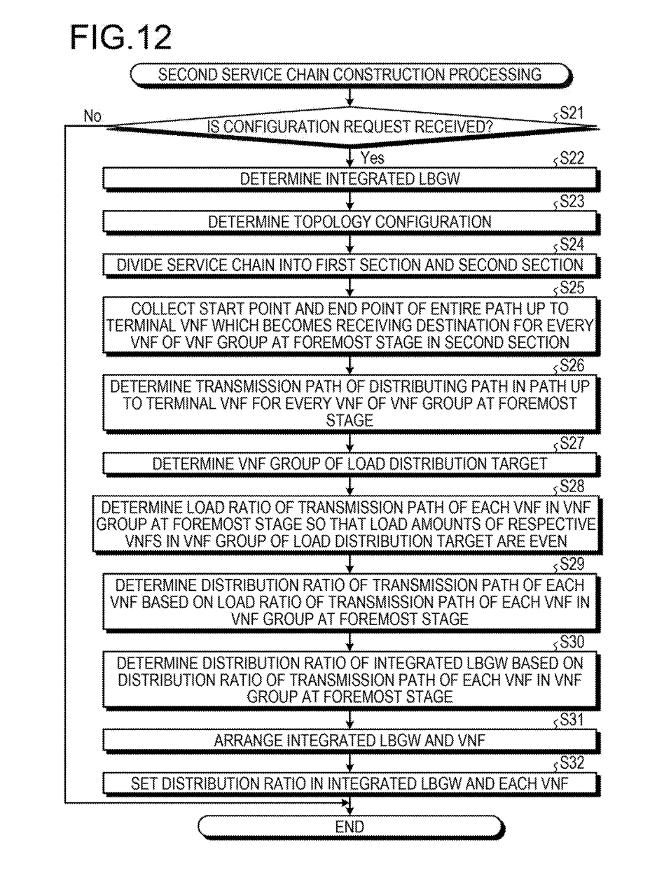

Subsequently, the operation of the service chain system 1 according to the first embodiment is described. FIG. 12 is a flowchart illustrating an example of a processing operation in a management server 3 that is related to a second service chain construction processing. The second service chain construction processing illustrated in FIG. 12 is a processing of constructing the service chain in which the integrated LBGW 15A is disposed immediately in the front of the VNF group 20 at the forefront stage on the virtual area according to the configuration request from the terminal device 4.

In FIG. 12, the first determination unit 41 of the processor 36 in the management server 3 determines whether the configuration request is received from the terminal device 4 (operation S21). When it is determined that the first determination unit 41 receives the configuration request (“Yes” in operation S21), the first determination unit 41 determines the number of the integrated LBGWs 15A based on the number of instances of the VNF 12 in the VNF group 20 in the configuration request and the number of instances of the LBGW 15 for every VNF group 20 (operation S22). Further, the first determination unit 41, for example, specifies the VNF group 20 in which the number of instances of the VNF 12 is the maximum number among the VNF groups 20 at the higher level in the configuration request, and determines the number of LB instances of the specified VNF group 20 as the number of integrated LBGWs 15A. In addition, the first determination unit 41 determines a topology configuration of the integrated LBGW 15A and the VNF group 20 based on the VNF group 20 in the configuration request (operation S23).

The first determination unit 41 divides the service chain of the topology configuration into the first section 51 and the second section 52 (operation S24). Further, the first section 51 is a section between the integrated LBGW 15A and VNF group #1 at the forefront stage, and the second section 52 is a section between VNF group #1 at the forefront stage and VNF group #3 at the terminal stage. The fourth determination unit 42A determines a start point and an end point of an entire path up to the terminal VNF 12 which becomes a receiving destination of VNF group #1 at the forefront stage in the second section 52 (operation S25). Further, the fourth determination unit 42A determines the start point and the end point of each path up to the front of the Proxy 1 and the Proxy 2 which become the terminal receiving destinations of the FW 1 to FW 4 in the second section 52.

The fifth determination unit 42B determines the transmission path of distributing the entire path from the VNF group 20 at the forefront stage up to the terminal VNF 12, which is determined by the fourth determination unit 42A (operation S26). The sixth determination unit 42C specifies the VNF group 20 of a load distribution target (operation S27). Herein, the VNF group 20 of the load distribution target is set as, for example, the IDS 1 to the IDS 3 of VNF #2.

The sixth determination unit 42C determines the load ratio of the transmission path of each VNF 12 in the VNF group 20 at the forefront stage so that the load amounts of the respective VNFs 12 in the VNG group 20 of the load distribution target are even in the entire path from the VNG group 20 at the forefront stage up to the terminal VNF 12, which is determined by the fifth determination unit 42B (operation S28). Further, the sixth determination unit 42C determines the load ratio of the transmission path of each of the FW 1 to FW 4 in VNF #1 in the second section 52. The sixth determination unit 42C determines the load ratio of the transmission path of each VNF 12 based on the load ratio of the transmission path of each of the FW 1 to FW 4 in VNF #1 (operation S29).

The third determination unit 43 determines the distribution ratio of the integrated LBGW 15A based on the load ratio of the transmission path of each of the FW 1 to FW 4 in VNF #1 (operation S30). The arrangement unit 44A arranges the integrated LBGW 15A and the VNF 12 in the virtual area on the COTS server 2B to actuate the functions of the integrated LBGW 15A and the VNF 12 based on the transmission paths of the integrated LBGW 15A and the VNF 12 (operation S31).

The ratio setting unit 44B sets the distribution ratio of the integrated LBGW 15A, which is determined by the third determination unit 43 in the integrated LBGW 15A on the virtual area, and sets the load ratio of each VNF 12, which is determined by the sixth determination unit 42C in each VNF 12 on the virtual area (operation S32). The ratio setting unit 44B ends the processing operation illustrated in FIG. 12. As a result, the service chain according to the configuration request may be disposed on the virtual area.

The management server 3 according to the first embodiment arranges the plurality of integrated LBGWs 15A just before the VNF group 20 at the forefront stage of the service chain and determines the load ratio of the VNF group 20 at the forefront stage so that the load amounts from the VNF group 20 at the forefront stage to the terminal VNF 12 become even. Further, the management server 3 calculates the distribution ratio of the integrated LBGW 15A to set the distribution ratio of the integrated LBGW 15A in the integrated LBGW 15A and set the load ratio of each VNF 12 in each VNF 12, based on the load ratio of the VNF group 20 at the forefront stage. As a result, the number of the integrated LBGWs 15A is decreased so that the transmission delay may be suppressed, the limited resources of the virtual area may be saved, and the loads reflected to additional installation of the VNF 12 may be distributed even though the number of the VNFs 12 after the integrated LBGW 15A is increased.

In the above-described embodiment, a case where information on the VNF group 20 and the integrated LBGW 15A used in the VNF group 20 is included as a format of the configuration request is exemplified, but when the number of the integrated LBGWs 15A used for every VNF group 20 is one, the information on the used integrated LBGW 15A may not be included. As a result, a capacity of the configuration request may be compacted.

The management server 3 determines the number of the integrated LBGWs 15A disposed at the previous stage of the VNF group 20 (VNF #1) at the forefront stage based on the number of LB instances for every VNF group 20 designated at the time of arranging the VNF groups 20 on the virtual area in multiple stages. As a result, the management server 3 may determine the minimum number of the integrated LBGWs 15A required for constructing the service chain.

The management server 3 specifies a predetermined functional characteristic of each VNF group 20 designated by the configuration request, for example, the L4-level VNF group 20, and determines the number of integrated LBGWs 15A according to the number of LB instances in the specified VNF group 20. As a result, the management server 3 may determine the minimum number of integrated LBGWs 15A, which is suitable for the predetermined functional characteristic at the time of constructing the service chain.

The management server 3 specifies a predetermined functional characteristic of each VNF group 20 designated by the configuration request, for example, the L4-level VNF group 20. Further, the management server 3 specifies the VNF group 20 in which the number of VNFs 12 is the maximum number among the specified VNF groups 20. In addition, the management server 3 determines the number of integrated LBGWs 15A according to the number of LB instances of the specified VNF group 20. As a result, the management server 3 may be suitable for the VNF group 20 accommodating the maximum number of VNFs 12 of the predetermined functional characteristic and further, may determine the minimum number of integrated LBGWs 15A at the time of constructing the service chain.

The management server 3 specifies a higher layer characteristic, for example, the L4-level VNF group 20 among the respective VNF groups 20 designated by the configuration request, and determines the number of integrated LBGWs 15A according to the number of LB instances in the specified VNF group 20. As a result, the management server 3 may be suitable for the VNF group 20 accommodating the VNF 12 of the higher layer characteristic and further, may determine the number of integrated LBGWs 15A at the time of constructing the service chain.

The management server 3 specifies the VNF group 20 of the higher layer characteristic among the plurality of VNF groups 20 based on the number of VNFs 12 for every VNF group 20 designated by the configuration request. Further, the management server 3 determines the number of integrated LBGWs 15A and deletes the number of designated LBs according to the number of LB instances in the specified VNF group 20.

In the above-described embodiment, the number of integrated LBGWs 15A is determined according to the number of LB instances designated by the configuration request. However, the number of LB instances may not be included in the configuration request. In this case, the management server 3 calculates processing performance required for every VNF group 20 and calculates the number of LB instances, which is required for processing the calculated processing performance, based on the number of instances of the VNF 12 of the VNF group 20 designated by the configuration request. In addition, the management server 3 may determine the number of integrated LBGWs 15A based on the number of LB instances for every VNF group 20 which is calculated by the management server 3.

When the first determination unit 41 according to the above-described embodiment detects the configuration request, the first determination unit 41 specifies the VNF group 20 at the L4 level which is the higher layer in the configuration request and specifies the VNF group 20 in which the number of instances of the VNF 12 is the maximum number among the specified VNF groups 20. In addition, the first determination unit 41 determines the number of integrated LBGWs 15A according to the number of LB instances in the specified VNF group 20. However, the present invention is not limited thereto.

In the above-described embodiment, the optimal path of the VNF group 20 at the forefront stage in the second section 52 is determined to calculate the load ratio of each VNF 12 in the VNF group 20 at the forefront stage. However, the load ratio of each VNF 12 in the VNF group 20 at the forefront stage may be calculated and thereafter, the optimal path from the VNF group 20 at the forefront stage up to the terminal VNF 12 may be determined.

In the above-described embodiment, the distribution ratio of the integrated LBGW 15A is calculated and thereafter, the load ratio for every VNF 12 of the optimal path is calculated. However, the load ratio for every VNF 12 of the optimal path may be calculated and thereafter, the distribution ratio of the integrated LBGW 15A may be calculated, or the load ratio for every VNF 12 of the optimal path and the distribution ratio of the integrated LBGW 15A may be simultaneously calculated by using a specific algorithm.

In the above-described embodiment, the number of integrated LBGWs 15A is determined as the number of LB instances of the VNF group 20 of the functional characteristic, for example, the L4 level among the multiple VNF groups 20 designated by the configuration request. However, as the functional characteristic, for example, the VNF group 20 using a calculation function to distribute the loads by a hash calculation of a transmitting source address may be specified, and the number of integrated LBGWs 15A may be determined as the number of LB instances of the specified VNF group 20.

In the embodiment, the number of LB instances of each VNF group 20 designated by the configuration request may be integrated to the LB 13 at the forefront stage to calculate the number of LB instances at the forefront stage. Further, the configuration request may be provided, which designates the integrated LBGW 15A at the forefront stage, the next-stage VNF 12 connected to the integrated LBGW 15A, and the number of instances of the VNF 12.

In the embodiment, the path from the VNF group 20 at the forefront stage of the integrated LBGW 15A up to the terminal VNF 12 is calculated and thereafter, the load ratio of each VNF 12 and the distribution ratio of the integrated LBGW 15A are calculated so that the loads of the respective VNFs 12 in the VNF group 20 of the load distribution target in the second section 52 are evenly distributed. However, the present invention is not limited to the VNF 12 in the VNF group 20 of the load distribution target in the second section 52, but the load ratio of each VNF 12 and the distribution ratio of the integrated LBGW 15A may be calculated so that the loads of all VNFs 12 of all VNF groups 20 in the second section 52 are evenly distributed. Further, the management server 3 determines the transmission path of each VNF 12 and thereafter, calculates the load ratio of each VNF 12, but may calculate the transmission path and the load ratio for every VNF 12 at the same time.

Each component of the respective illustrated units is not necessarily required to be configured physically as illustrated. That is, specific forms of distribution or integration of the individual units are not limited to those illustrated, and all or some of the units may be configured to be functionally or physically distributed or integrated in arbitrary units depending on various loads or use situations.

All or some of the various processing functions performed by the respective devices may be implemented on a central processing (CPU), a digital signal processor (DSP), a field programmable gate array (FPGA), or the like. In addition, all or some of the various processing functions may be performed on a program analyzed and executed by the CPU, etc., or on hardware by a wired logic.

The area storing the various kinds of information may be constituted by, for example, a read only memory (ROM) or a random access memory (RAM) such as a synchronous dynamic random access memory (SDRAM), a magentoresistive random access memory (MRAM), or a non volatile random access memory (NVRAM).

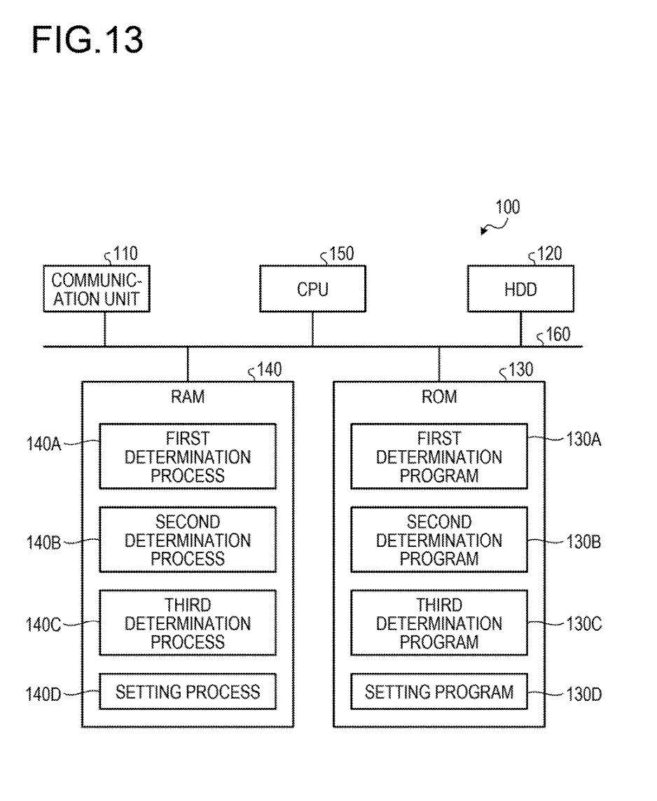

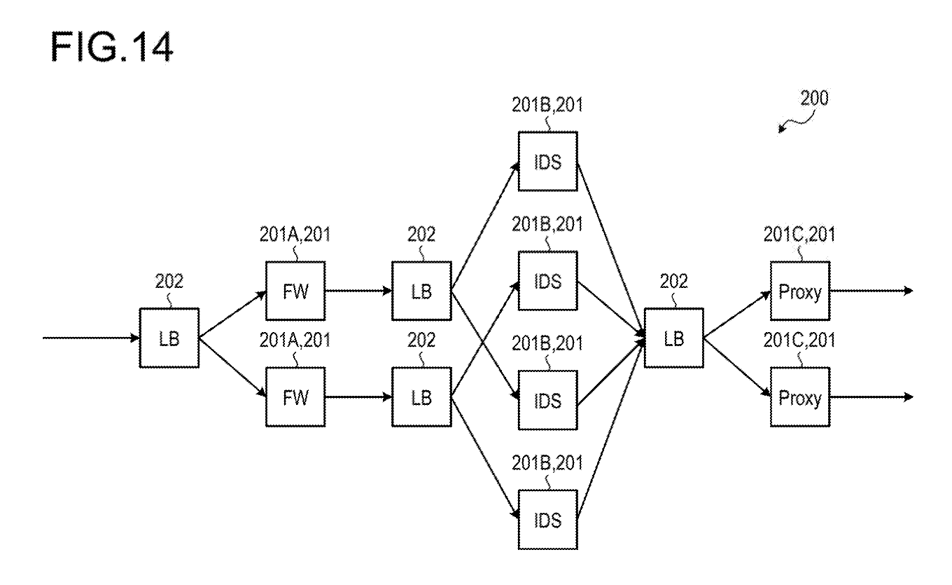

However, the various processings described in the embodiment may be implemented by executing a previously prepared program by means of a processor such as the CPU, in the computer. Therefore, hereinafter, an example of the information processing apparatus 100 that executes the program having the same function as the embodiment will be described. FIG. 13 is an explanatory diagram illustrating an example of an information processing apparatus 100 that executes a service chain construction program.

The information processing apparatus 100 executing the service chain construction program illustrated in FIG. 13 includes a communication unit 110, a hard disc drive (HDD) 120, a ROM 130, a RAM 140, and a CPU 150. The communication unit 110, the HDD 120, the ROM 130, the RAM 140, and the CPU 150 are connected to each other through a bus 160. The communication unit 110 is connected to another information processing apparatus (not illustrated) to communicate with another information processing apparatus. In addition, the information processing apparatus 100 arranges the virtual communication function groups on the virtual area in another information processing apparatus in multiple stages in communication with another information processing apparatus to configure the service chain.

The service chain construction program that shows the same function as the embodiment is previously stored in the ROM 130. The ROM 130 stores a first determination program 130A, a second determination program 130B, a third determination program 130C, and a setting program 130D as the service chain construction program. Further, the service chain construction program may be recorded in not the ROM 130 but a computer readable recording medium as a drive (not illustrated). Further, as the recording medium, for example, a portable recording medium such as a CD-ROM, a DVD, or a USB memory, or a semiconductor memory such as a flash memory may be used.

Then, the CPU 150 reads the first determination program 130A from the ROM 130 to make the read first determination program 130A function as the first determination process 140A on the RAM 140. Further, the CPU 150 reads the second determination program 130B from the ROM 130 to make the read second determination program 130B function as the second determination process 140B on the RAM 140. Moreover, the CPU 150 reads the third determination program 130C from the ROM 130 to make the read third determination program 130C function as the third determination process 140C on the RAM 140. In addition, the CPU 150 reads the setting program 130D from the ROM 130 to make the setting program 130D function as the setting process 140D on the RAM 140.

The CPU 150 is disposed at the previous stage of the virtual communication function group at the forefront stage among the virtual communication function groups disposed in the multiple stages and further, determines a virtual distribution function to distribute traffic to a virtual communication function in the virtual communication function group at the forefront stage. The CPU 150 determines a transmission path from each virtual communication function in the virtual communication function group at the forefront stage up to each virtual communication function in the virtual communication function group at a terminal stage among the virtual communication function groups disposed in the multiple stages. The CPU 150 determines a distribution ratio of the traffic of the virtual distribution function for each virtual communication function in the virtual communication function group at the forefront stage based on a traffic amount for every transmission path, which is determined. The CPU 150 sets the determined transmission path in each virtual communication function and sets the determined distribution ratio of the virtual distribution function in the virtual distribution function. As a result, even though the virtual communication function is additionally installed at the rear end of the virtual distribution function, the load distribution by the increase of the virtual communication function may be reflected.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A server apparatus comprising:
a memory; and
a processor coupled to the memory and the processor configured to:
determine a number of a virtual distribution function to be arranged at a previous stage of a first virtual communication function group arranged at a forefront stage among a plurality of virtual communication function groups arranged at a plurality of stages, the virtual distribution function distributing traffic to a virtual communication function in the first virtual communication function group;
determine a transmission path from the virtual communication function in the first virtual communication function group up to the virtual communication function in a final virtual communication function group arranged at a terminal stage among the plurality of virtual communication function groups;
determine a distribution ratio of the traffic of the virtual distribution function for the virtual communication function in the first virtual communication function group, based on a traffic amount for the determined transmission path;
set the determined transmission path into the virtual communication function; and
set the determined distribution ratio into the virtual distribution function.

2. The server apparatus according to claim 1,
wherein the processor is further configured to:
determine the virtual communication function to terminate the transmission path in the final virtual communication function group;
determine the transmission path for each of a plurality of virtual communication functions arranged on an optimal path from the virtual distribution function up to the virtual communication function in the final virtual communication function group;
determine the traffic amount of the virtual communication function in the first virtual communication function group so that traffic amounts of the plurality of virtual communication functions in a specific virtual communication function group are even among the plurality of virtual communication function groups arranged on the transmission path;
determine the traffic amount of each of the plurality of virtual communication functions arranged for every transmission path, based on the determined traffic amount of the virtual communication function in the first virtual communication function group;
arrange the virtual distribution function and the virtual communication function in a virtual area of the server apparatus, based on the determined number of the virtual distribution function and the determined transmission path for each of the plurality of virtual communication functions;
set the determined distribution ratio into the virtual distribution function on the virtual area; and
set the determined traffic amount of the virtual communication function in the first virtual distribution function group and the determined traffic amount of each of the plurality of virtual communication functions arranged for every transmission path into the virtual communication function in the virtual area of the server apparatus.

3. A virtual communication construction method comprising:
determining a number of a virtual distribution function to be arranged at a previous stage of a first virtual communication function group arranged at a forefront stage among a plurality of virtual communication function groups arranged at a plurality of stages, the virtual distribution function distributing traffic to a virtual communication function in the first virtual communication function group;
determining a transmission path from the virtual communication function in the first virtual communication function group up to the virtual communication function in a final virtual communication function group arranged at a terminal stage among the plurality of virtual communication function groups;
determining a distribution ratio of the traffic of the virtual distribution function for the virtual communication function in the first virtual communication function group, based on a traffic amount for the determined transmission path;
setting the determined transmission path into the virtual communication function; and
setting the determined distribution ratio into the virtual distribution function, by a processor.
